(19) United States
(12) Patent Application Publication
(10) Pub. No.: US 2021/0223214 A1
(43) Pub. Date: Jul. 22, 2021

(54) METHOD OF COMPLEX MODAL IDENTIFICATION FOR THE STRUCTURE WITH PROPORTIONAL DAMPING

(71) Applicant: DALIAN UNIVERSITY OF TECHNOLOGY, Dalian, Liaoning (CN)

(72) Inventors: Chunxu QU, Dalian, Liaoning (CN); Tinghua YI, Dalian, Liaoning (CN); Hongnan LI, Dalian, Liaoning (CN)

(21) Appl. No.: 17/046,713

(22) PCT Filed: Nov. 6, 2019
(86) PCT No.: PCT/CN2019/115898

§ 371 Date: Oct. 9, 2020

(30) Foreign Application Priority Data
Oct. 24, 2019 (CN) 201911017829.1

(51) Int. Cl. G01N 29/46

(52) U.S. Cl. CPC G01N 29/46; G01N 2291/023

(57) ABSTRACT

The presented invention belongs to the technical field of data analysis for engineering structural monitoring, and relates to a method of complex modal identification for the structure with proportional damping. Firstly, the set of single source points containing the real modal shapes are obtained by short time Fourier transform and single source point detection, and then the real modal shapes are calculated by hierarchical distance method. Then, the impulse response and its Hilbert transform are obtained by natural excitation technology and Hilbert transform, respectively. The relationship between modal response and impulse response with its Hilbert transform is established. Finally, the complex modal parameters are solved. In this invention, the procedures of hidden complex modes of structures with proportional damping are given by explicit expression, which reveal the structural dynamic characteristics essentially.

### TECHNICAL FIELD

The presented invention belongs to the technical field of data analysis for engineering structural monitoring and relates to a method of complex modal identification for the structure with proportional damping.

### BACKGROUND

Structural health monitoring is an important way to guarantee structural safety. The modal parameters reflect structural dynamic characteristics, which can be used for evaluation of structural performance. Therefore, it is very important to identify structural modal parameters by using structural monitoring data.

Structural modal parameters contain frequencies, modal shapes and damping ratio. Structures in practical engineering are always assumed to have proportional damping. This kind of structures are identified by the existing modal identification methods to identify this kind of structures give the real modal parameters. However, the actual modes are complex. The conjugate imaginary parts cancel each other, which shows the fake phenomenon of real modes. Identifying the hidden complex modal information is the key to reveal structural dynamic characteristics.

There are many methods of modal parameter identification in engineering. Juang and Pappa in 1985 proposed the eigensystem realization algorithm, which uses impulse response to identify modal parameters. Overschee and Moor in 2012 presented the stochastic subspace identification method, which uses white excitation response to identify modal parameters. Qu et al. in 2019 proposed to reduce the environmental noise in the frequency domain using the concept of transfer function, and converted the transfer function to impulse response function for modal identification. Yao et al. in 2018 proposed to use the framework of blind source separation to identify modal parameters. Antunes et al. in 2018 identified the complex modes using the blind identification method through analytic signals. Bajri'c and Hogsberg in 2018 gave the damping matrix expression, which is formed by the complex eigenvectors and eigenvalues of a non-classically damped structure. However, engineering structures are stable for a long time, which reflects the characteristics of proportional damping structure. It is difficult to obtain the actual complex modal information of the structure and grasp the dynamic characteristics of the structure using above methods. Therefore, it is necessary to identify the complex modes of the structure with proportional damping.

### SUMMARY

The objective of the presented invention is to provide a method of complex modal identification for the structures with proportional damping, which solve the problem of hidden complex modal identification in the process of modal identification of structures with proportional damping.

The technical solution of the presented invention is as follows:

The complex modal identification method for the structures with proportional damping is derived. Firstly, the short-time Fourier transform is applied to the structural response under the environmental excitation. Through single source point detection and mature hierarchical clustering method, the real modal shapes are obtained. The structural response under the environmental excitation is transformed into impulse response signal through the mature natural excitation technology, which is then transformed by Hilbert transform. The functional relationship is established between modal response and impulse response with its Hilbert transform, which is used to find out the relationship coefficient between real mode and complex mode. After taking the coefficient into the modal response, the complex frequencies can be calculated by the ratios of modal response of two adjacent moments. The damping ratios are calculated by complex frequencies. Thus, three modal parameters including complex mode, complex frequency and damping ratio are identified.

The steps of the complex modal identification method for the structure with proportional damping are as follows:

Step 1: Real Modal Shape Matrix Identification

(1) The structural acceleration responses at k-th time step y(k)=[y₁(k), y₂(k), . . . , yₗ(k)]^{T} are collected. The time-domain acceleration response is transformed into time-frequency domain by short-time Fourier transform, which can be expressed as Y(K,ω)=[Y₁(K,ω), Y₂ (K,ω), . . . , Yₗ(K,ω)], where l is the number of accelerometers, K is expression is the K-th time interval, ω is natural circular frequency;

(2) Single source points can reflect single modal information. The single source point detection of circular frequency is based on the fact that the real part and the imaginary part of the time-frequency coefficient have the same direction. The single source points can be detected by the following formula

$$\vert \frac{Re {\{ Y ( K , ω ) \}}^{T} Im \{ Y ( K , ω ) \}}{‖ Re \{ Y ( K , ω ) \} ‖ ‖ Im \{ Y ( K , ω ) \} ‖} \vert > cos ( Δβ ) ,$$

where Re {⋅} and Im{⋅} are the real and imaginary part, respectively, Δβ is the threshold of single source point detection that can be set to 2°.

The detected single-source-points are marked as (t_{K},ω_{K,i}), whose values are denoted as:

Y(K,ω_{K,i})=[Y₁(K,ω_{K,i}),Y₂(K,ω_{K,i}), . . . ,Yₗ(K,ω_{K,i})]^{T}

where the symbol “κ, i” represents the i-th frequency in the K-th time interval;

(3) The number of clusters is determined by the number of obvious peaks in the power spectral density of acceleration response. The single source points Y(K,ω_{K,i}) are classified using mature hierarchical clustering method. The clustering centers of each class are calculated, and the real modal shape matrix Φ^{R} is obtained;

Step 2: Complex Mode Calculation

(4) The structural response y(k) is converted to impulse response y_{d}(k) using mature natural excitation technology. The Hilbert transform of y_{d}(k) is then performed and denoted as ŷ_{d}(k);

(5) Build the following equation:

$$[ \begin{matrix}{y}_{d} ( k ) \\ {\hat{y}}_{d} ( k )\end{matrix} ] = [ \begin{matrix}{Φ}^{R} & - {Φ}^{I} \\ {Φ}^{I} & {Φ}^{R}\end{matrix} ] [ \begin{matrix}{q}^{R} ( k ) \\ {q}^{I} ( k )\end{matrix} ] = [ \begin{matrix}{Φ}^{R} & - {Φ}^{R} γ \\ {Φ}^{R} γ & {Φ}^{R}\end{matrix} ] [ \begin{matrix}{q}^{R} ( k ) \\ {q}^{I} ( k )\end{matrix} ]$$

where Φ^{I} is the image part of complex modal shapes Φ^{R}±jΦ^{I}, and satisfies Φ^{I}=Φ^{R}γ, j is the imaginary unit and satisfies j²=−1, q^{R} and q^{I} are modal responses and satisfies the following:

y_{d}(k)=[Φ^{R}+jΦ^{I}][q^{R}+jq^{I}]^{T}+[Φ^{R}−jΦ^{I}][q^{R}−jq^{I}]^{T}

(6) The expressions of q^{R} and q^{I} are obtained by the pseudo inverse of the above equation, which are expressed by the unknown parameter γ:

$$[ \begin{matrix}{q}^{R} ( k ) \\ {q}^{I} ( k )\end{matrix} ] = [ \begin{matrix}{Φ}^{R} & - {Φ}^{R} γ \\ {Φ}^{R} γ & {Φ}^{R}\end{matrix} ] [ \begin{matrix}{y}_{d} ( k ) \\ {\hat{y}}_{d} ( k )\end{matrix} ]$$

where the symbol “^{†}” denotes pseudo inverse;

(7) The expressions of q^{R} and q^{I} with the unknown parameter γ are taken into the following formula to calculate the unknown parameter γ:

$$[ {q}^{R} ( k + 1 ) + {jq}^{I} ( k + 1 ) ] . / [ {q}^{R} ( k ) + {jq}^{I} ( k ) ] = \\ [ {q}^{R} ( k + 2 ) + {jq}^{I} ( k + 2 ) ] . / [ {q}^{R} ( k + 1 ) + {jq}^{I} ( k + 1 ) ]$$

where the symbol “./” denotes element-wise division, i.e. the element in a vector is divided separately, k represents the k-th time step;

(8) The modal shape imaginary part Φ^{I} is then obtained by Φ^{I}=Φ^{R}γ according to the calculated real modal shape matrix Φ^{R} in procedure (3) and calculated parameter γ in procedure (7);

(9) The modal responses q^{R} and q^{I} are obtained by taking the parameter γ in procedure (7) into the expressions of q^{R} and q^{I} in procedure (6);

(10) The complex frequencies are calculated by the following expression:

ω^{R}+jω^{I}=[q^{R}(k+1)+jq^{I}(k+1)]./[q^{R}(k)+jq^{I}(k)]

where ω^{R} and ω^{I} are the real and imaginary parts of complex frequencies, respectively;

(11) The damping ratio is calculated by the following expression:

$${ζ}_{i} = - \frac{Re \{ ln ( {ω}_{i}^{R} + j {ω}_{i}^{I} ) \}}{\vert ln ( {ω}_{i}^{R} + j {ω}_{i}^{I} ) \vert}$$

where ωᵢ^{R} and ωᵢ^{I} are the i-th element of ω^{R} and ω^{I}, i.e. real and imaginary parts of the i-th complex frequency.

So far, the complex modal parameters ω^{R}±jω^{I}, Φ^{R}±jΦ^{I} and ζᵢ are obtained.

The advantage of the invention is that the hidden complex modal information in the structures with proportional damping can be obtained. The presented invention uses the analytical way to identify modes, which has simple procedures and does not need the iterative calculation. The complex modes of the structures with the proportional damping can reveal the structural dynamic characteristics.

### DETAILED DESCRIPTION

The presented invention is further described below in combination with the technical solution.

The numerical example of 3 degree-of-freedom in-plane lumped-mass model is employed. The mass for each floor and stiffness for each story are 1×10³ kg, 2×10³ kg, 1×10³ kg, respectively. The stiffness and damping matrices are as follows:

$$K = [ \begin{matrix}5 & - 1 & 0 \\ - 1 & 4 & - 3 \\ 0 & - 3 & 3.5\end{matrix} ] \times 1 {0}^{6} N / m$$

$$C = [ \begin{matrix}7.2215 & - 1.1274 & 0 \\ - 1.1274 & 7.6785 & - 3.3823 \\ 0 & - 3.3823 & 5.5304\end{matrix} ] \times 1 {0}^{3}$$

The model is excited by white noise, and the response is contaminated by 20% of the variance of the free vibration response. The measurement is the acceleration. The steps are described as follows:

Step 1: Real Modal Shape Matrix Identification

(1) The structural acceleration responses at k-th time step y(k)=[y₁(k), y₂ (k), . . . , yₗ(k)]^{T} are collected. The time-domain acceleration response is transformed into time-frequency domain by short-time Fourier transform, which can be expressed as Y(K,ω), where l is the number of accelerometers, K is expression is the K-th time interval, ω is natural circular frequency;

(2) The single source points can be detected by the following formula

$$\vert \frac{Re {\{ Y ( K , ω ) \}}^{T} Im \{ Y ( K , ω ) \}}{‖ Re \{ Y ( K , ω ) \} ‖ ‖ Im \{ Y ( K , ω ) \} ‖} \vert > cos ( 2 ° ) ,$$

where Re {⋅} and Im{⋅} are the real and imaginary part, respectively. The detected single-source-points are denoted as:

Y(K,ω_{K,i})=[Y₁(K,ω_{K,i}),Y₂(K,ω_{K,i}), . . . ,Yₗ(K,ω_{K,i})]^{T}

where the symbol “_{K,i}” represents the i-th frequency in the K-th time interval;

(3) The number of clusters is determined to be 3 according to the number of obvious peaks in the power spectral density of acceleration response. The single source points Y(K,ω_{K,i}) are classified using mature hierarchical clustering method. The clustering centers of each class are calculated, and the real modal shape matrix

$${Φ}^{R} = [ \begin{matrix}1 & 1 & 1 \\ - 0.4668 & 0.3962 & 4.9025 \\ 0.7134 & - 1.0452 & 4.7853\end{matrix} ]$$

is obtained;

Step 2: Complex Modal Calculation

(4) The structural response y(k) is converted to impulse response y_{d}(k) using mature natural excitation technology. The Hilbert transform of y_{d}(k) is then performed and denoted as ŷ_{d}(k);

(5) The expressions of q^{R} and q^{I} are expressed by the unknown parameter γ:

$$[ \begin{matrix}{q}^{R} ( k ) \\ {q}^{I} ( k )\end{matrix} ] = [ \begin{matrix}{Φ}^{R} & - {Φ}^{R} γ \\ {Φ}^{R} γ & {Φ}^{R}\end{matrix} ] [ \begin{matrix}{y}_{d} ( k ) \\ {\hat{y}}_{d} ( k )\end{matrix} ]$$

where the symbol “^{†}” denotes pseudo inverse, Φ^{I} is the image part of complex modal shapes, and satisfies Φ^{I}=Φ^{R}γ;

(6) The expressions of q^{R} and q^{I} are taken into the following formula to calculate the unknown parameter γ=diag([18.0156, 17.6482, 17.1870]):

$$[ {q}^{R} ( k + 1 ) + {jq}^{I} ( k + 1 ) ] . / [ {q}^{R} ( k ) + {jq}^{I} ( k ) ] = \\ [ {q}^{R} ( k + 2 ) + {jq}^{I} ( k + 2 ) ] . / [ {q}^{R} ( k + 1 ) + {jq}^{I} ( k + 1 ) ]$$

where “diag” represents the diagonal matrix, the symbol “./” denotes element-wise division, i.e. the element in a vector is divided separately, j is the imaginary unit and satisfies j²=−1, k represents the k-th time step;

(7) The modal shape imaginary part Φ^{I} is then obtained by Φ^{I}=Φ^{R}γ according to the calculated real modal shape matrix Φ^{R} in procedure (3) and calculated parameter γ in procedure (6);

(8) The modal responses q^{R} and q^{I} are obtained by taking the parameter γ in procedure (6) into the expressions of q^{R} and q^{I} in procedure (5);

(9) The complex frequencies are calculated by the following expression:

ω^{R}+jω^{I}=[q^{R}(k+1)+jq^{I}(k+1)]./[q^{R}(k)+jq^{I}(k)]

where ω^{R} and ω^{I} are the real and imaginary parts of complex frequencies, respectively;

(10) The damping ratio is calculated by the following expression:

$${ζ}_{i} = - \frac{Re \{ ln ( {ω}_{i}^{R} + j {ω}_{i}^{I} ) \}}{\vert ln ( {ω}_{i}^{R} + j {ω}_{i}^{I} ) \vert}$$

where ωᵢ^{R} and ωᵢ^{I} are the i-th element of ω^{R} and ω^{I}, i.e. real and imaginary parts of the i-th complex frequency.

1. A method of complex modal identification for the structure with proportional damping, wherein comprising the following steps:
step 1: real modal shape matrix identification
(1) structural acceleration responses at k-th time step y(k)=[y₁(k), y₂(k), . . . , yₗ(k)]^{T} are collected; time-domain acceleration responses are transformed into time-frequency domain by short-time Fourier transform, which are expressed as Y(K,ω)=[Y₁(K,ω), Y₂(K,ω), . . . , Yₗ(K,ω)], where l is number of accelerometers, K is expression is K-th time interval, ω is natural circular frequency;
(2) single source points reflect single mode information; the single source point detection of circular frequency is based on the fact that real part and imaginary part of time-frequency coefficient have same direction; the single source points are detected by the following formula
$$\vert \frac{Re {\{ Y ( K , ω ) \}}^{T} Im \{ Y ( K , ω ) \}}{‖ Re \{ Y ( K , ω ) \} ‖ ‖ Im \{ Y ( K , ω ) \} ‖} \vert > cos ( Δβ ) ,$$
where Re{⋅} and Im{⋅} are the real and imaginary part, respectively, Δβ is threshold of single source point detection;
the detected single-source-points are marked as (t_{K},ω_{K,i}), whose values are denoted as:
Y(K,ω_{K,i})=[Y₁(K,ω_{K,i}),Y₂(K,ω_{K,i}), . . . ,Yₗ(K,ω_{K,i})]^{T}
where symbol “_{K,i}” represents i-th frequency in K-th time interval;
(3) number of clusters is determined by number of obvious peaks in power spectral density of acceleration response; the single source points Y(K,ω_{K,i}) are classified using mature hierarchical clustering method; clustering centers of each class are calculated, and the real modal shape matrix Φ^{R} is obtained;
step 2: complex mode calculation
(4) the structural acceleration responses y(k) are converted to impulse response y_{d}(k) using mature natural excitation technology; Hilbert transform of impulse response y_{d}(k) is then performed and denoted as ŷ_{d}(k);
(5) build the following equation:
$$[ \begin{matrix}{y}_{d} ( k ) \\ {\hat{y}}_{d} ( k )\end{matrix} ] = [ \begin{matrix}{Φ}^{R} & - {Φ}^{I} \\ {Φ}^{I} & {Φ}^{R}\end{matrix} ] [ \begin{matrix}{q}^{R} ( k ) \\ {q}^{I} ( k )\end{matrix} ] = [ \begin{matrix}{Φ}^{R} & - {Φ}^{R} γ \\ {Φ}^{R} γ & {Φ}^{R}\end{matrix} ] [ \begin{matrix}{q}^{R} ( k ) \\ {q}^{I} ( k )\end{matrix} ]$$
where Φ^{I} is image part of complex modal shapes Φ^{R}±jΦ^{I}, and satisfies Φ^{I}=Φ^{R}γ, j is imaginary unit and satisfies j²=−1, q^{R} and q^{I} are modal responses and satisfies the following:
y_{d}(k)=[Φ^{R}+jΦ^{I}][q^{R}+jq^{I}]^{T}+[Φ^{R}−jΦ^{I}][q^{R}−jq^{I}]^{T}
(6) expressions of q^{R} and q^{I} are obtained by pseudo inverse of the above equation, which are expressed by unknown parameter γ:
$$[ \begin{matrix}{q}^{R} ( k ) \\ {q}^{I} ( k )\end{matrix} ] = [ \begin{matrix}{Φ}^{R} & - {Φ}^{R} γ \\ {Φ}^{R} γ & {Φ}^{R}\end{matrix} ] [ \begin{matrix}{y}_{d} ( k ) \\ {\hat{y}}_{d} ( k )\end{matrix} ]$$
where symbol “^{†}” denotes pseudo inverse;
(7) the expressions of q^{R} and q^{I} with the unknown parameter γ are taken into the following formula to calculate the unknown parameter γ:
$$[ {q}^{R} ( k + 1 ) + {jq}^{I} ( k + 1 ) ] . / [ {q}^{R} ( k ) + {jq}^{I} ( k ) ] = \\ [ {q}^{R} ( k + 2 ) + {jq}^{I} ( k + 2 ) ] . / [ {q}^{R} ( k + 1 ) + {jq}^{I} ( k + 1 ) ]$$
where symbol “./” denotes element-wise division, i.e. element in a vector is divided separately, k represents k-th time step;
(8) modal shape imaginary part Φ^{I} is then obtained by Φ^{I}=Φ^{R}γ according to the calculated real modal shape matrix Φ^{R} in procedure (3) and calculated parameter γ in procedure (7);
(9) the modal responses q^{R} and q^{I} are obtained by taking the parameter γ in procedure (7) into the expressions of q^{R} and q^{I} in procedure (6);
(10) complex frequencies are calculated by the following expression:
ω^{R}+jω^{I}=[q^{R}(k+1)+jq^{I}(k+1)]./[q^{R}(k)+jq^{I}(k)]
where ω^{R} and ω^{I} are real and imaginary parts of complex frequencies, respectively;
(11) damping ratio is calculated by the following expression:
$${ζ}_{i} = - \frac{Re \{ ln ( {ω}_{i}^{R} + j {ω}_{i}^{I} ) \}}{\vert ln ( {ω}_{i}^{R} + j {ω}_{i}^{I} ) \vert}$$
where ωᵢ^{R} and ωᵢ^{I} are i-th element of ω^{R} and ω^{I}, i.e. real and imaginary parts of i-th complex frequency.

2. The method of complex modal identification for the structure with proportional damping according to claim 1, wherein Δβ=2°.
